(19) United States
(12) Patent Application Publication
(10) Pub. No.: US 2005/0148234 A1
(43) Pub. Date: Jul. 7, 2005

(54) Apparatus for connecting a test unit to a data line

(75) Inventors: Martina Hofmann, Gross-Zimmern (DE); Peter Schlickenrieder, Holzkirchen (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/901,289

(22) Filed: Jul. 29, 2004

(30) Foreign Application Priority Data
Jul. 30, 2003 (DE) 10334813.1

(51) Int. Cl. H01R 31/08

(52) U.S. Cl. 439/509

(57) ABSTRACT

The invention relates to an apparatus for connecting a test unit to a data line, in particular in the driver's cab of a rail vehicle. It is provided for the data line to end at a first plug terminal and be routed from a second plug terminal. In this case, it is possible either to connect a test device to the first plug terminal or to connect the two plug terminals by means of a short-circuit device.

### CLAIM FOR PRIORITY

This application claims the benefit of priority to German Application No. 103 34 813.1, which was filed in the German language on Jul. 30, 2003, the contents of which are hereby incorporated by reference.

### TECHNICAL FIELD OF THE INVENTION

The invention relates to an apparatus for connecting a test unit to a data line, in particular in the driver's cab of a rail vehicle.

### BACKGROUND OF THE INVENTION

A data line generally leads from a sensor to a display or control unit. In a rail vehicle, such a data line can be laid over a great length and connect, for example, a brake to the driver's cab.

It is necessary for the data line to be tested at time intervals. For this purpose, a test device needs to be connected to the data line. This test device may be, for example, a portable computer (laptop).

It is already known to provide a connection for such a test device on the data line. For this purpose, a branch line originates from the data line which ends at a plug terminal. If required, the test device can then be connected to this plug terminal.

The branch line which is generally not used may, however, disrupt the flow of data in the data line. In addition, if a test device is inadvertently left connected to the branch line, this test device may impair the flow of data. The same applies if in each case a test device is inadvertently connected to both the branch line and a unit connected to the data line.

Until now, a complex test loop has therefore often been used for the data line.

### SUMMARY OF THE INVENTION

In one embodiment of the invention, there is an apparatus for connecting a test unit to a data line in a driver's cab of a rail vehicle, the data line ends at a first plug terminal and is routed from a second plug terminal, and is configured to connect a test device to the first plug terminal or to connect the two plug terminals by means of a short-circuit device.

In one aspect of the invention, the two plug terminals are parts of a conventional plug-in connection having two or more pins, and a first subset of the pins forms the first plug terminal and a second subset of the pins forms the second plug terminal.

In another aspect of the invention, the short-circuit device is a blind plug which can be plugged onto the conventional plug-in connection, and in which each part accommodating a pin of the first subset is conductively connected to a part which accommodates an associated pin of the second subset.

In still another aspect of the invention, the blind plug is integrated in a flap which is connected to the conventional plug-in connection by means of hinges.

In yet another aspect of the invention, the flap is a protective flap for the conventional plug-in connection.

### DETAILED DESCRIPTION OF THE INVENTION

The invention discloses an apparatus for connecting a test unit to a data line which operates without interference and makes it possible to connect a test device quickly and reliably. It is particularly necessary to prevent the situation from arising in which a test device remains connected unnoticed or in which two connected test devices have an interfering effect on one another.

In one embodiment according to the invention, the data line ending at a first plug terminal and being routed from a second plug terminal and by it being possible either to connect a test device to the first plug terminal or to connect the two plug terminals by means of a short-circuit device.

This provides one advantage that the data line does not have a branch line which is usually unused anyway. This is because such a branch line to which nothing is connected may bring about interference. It is therefore advantageously not necessary to test for interference. Furthermore, the advantage is achieved that it can be detected immediately whether a test device has not been removed again following the testing. Since in this case the short-circuit device is absent, no signal arrives at the end point, in particular in the driver's cab of the rail vehicle.

The two plug terminals are, for example, parts of a conventional plug-in connection having two or more pins. In this case, a first subset of the pins forms the first plug terminal and a second subset of the pins forms the second plug terminal. In each case half of the pins provided in the conventional plug-in connection generally form the two plug terminals. The pins are inserted in associated parts of plugs. These parts are, for example, either holders or recesses.

One advantage is achieved that the apparatus for connecting a test unit to a data line can be produced in a simple manner using a conventional component, namely the plug-in connection.

The short-circuit device is, for example, a blind plug which can be plugged onto the conventional plug-in connection, and in which each part accommodating a pin of the first subset is conductively connected to a part which serves the purpose of accommodating an associated pin of the second subset.

The advantage is achieved that, when the blind plug is plugged on, the data line has no interruption and no branch. There can thus be no interference affecting the flow of data. Simply removing the blind plug from the conventional plug-in connection provides access to a terminal for a test device, the terminal comprising the first subset of the pins of the conventional plug-in connection.

The design of the apparatus is particularly simple and particularly easy to work with. In particular, if a test device is connected, the connection to the end point of the data line remains interrupted, which means that the presence of a test device is always detected.

For example, the blind plug is integrated in a flap which is connected to the conventional plug-in connection by means of hinges.

This achieves the advantage that, merely owing to the flap being closed, the blind plug is positioned precisely. This makes it even easier to use the apparatus.

For example, the flap is a protective flap for the conventional plug-in connection. Such a protective flap is generally provided anyway. As a result of the fact that the blind plug is integrated in this protective flap, the design of the apparatus for connecting a test unit to a data line is further improved.

The apparatus for connecting a test unit to a data line achieves the particular advantage that the data line is largely not subjected to any interference, as long as a test is not being carried out. Furthermore, a test device may be connected quickly and reliably. In particular, it is possible to detect whether a test is currently being carried out or not.

1. An apparatus for connecting a test unit to a data line in a driver's cab of a rail vehicle, the data line ends at a first plug terminal and is routed from a second plug terminal, and is configured to connect a test device to the first plug terminal or to connect the two plug terminals by means of a short-circuit device.

2. The apparatus as claimed in claim 1, wherein the two plug terminals are parts of a conventional plug-in connection having two or more pins, and a first subset of the pins forms the first plug terminal and a second subset of the pins forms the second plug terminal.

3. The apparatus as claimed in claim 2, wherein the short-circuit device is a blind plug which can be plugged onto the conventional plug-in connection, and in which each part accommodating a pin of the first subset is conductively connected to a part which accommodates an associated pin of the second subset.

4. The apparatus as claimed in claim 3, wherein the blind plug is integrated in a flap which is connected to the conventional plug-in connection by means of hinges.

5. The apparatus as claimed in claim 4, wherein the flap is a protective flap for the conventional plug-in connection.
